(19) United States
(12) Patent Application Publication
(10) Pub. No.: US 2026/0008396 A1
(43) Pub. Date: Jan. 8, 2026

(54) COCKPIT MODULE FOR VEHICLE

(71) Applicant: HYUNDAI MOBIS CO., LTD., Seoul (KR)

(72) Inventors: Ik Keun CHOI, Yongin-si (KR); Da Som PARK, Yongin-si (KR)

(73) Assignee: HYUNDAI MOBIS CO., LTD., Seoul (KR)

(21) Appl. No.: 18/821,609

(22) Filed: Aug. 30, 2024

(30) Foreign Application Priority Data
Jul. 8, 2024 (KR) 10-2024-0089339

(51) Int. Cl. B60N 3/00; B60N 3/10; B60R 7/06; B60R 21/045

(52) U.S. Cl. CPC B60N 3/002; B60N 3/102; B60R 7/06; B60R 21/045

(57) ABSTRACT

A cockpit module for a vehicle is provided. The cockpit module includes a crash pad including an assembling hole, a tray including an internal space opened upward, the tray being assembled to the assembling hole, the internal space in communication with assembling hole, and a cover rotatably connected to the tray. In a closed position, the cover covers the internal space as a rotary shaft is rotatably connected to a protruding portion directed toward an inside of an occupant compartment of the tray, and in a deployed position, the cover opens the internal space by being moved upward along the rotary shaft. The cover includes a structure extending toward the inside of the occupant compartment, and the structure is used as a table at the deployed position.

### CROSS-REFERENCE TO RELATED APPLICATION(S)

The present application claims priority to and the benefit under 35 USC § 119 of Korean Patent Application No. 10-2024-0089339, filed on Jul. 8, 2024, in the Korean Intellectual Property Office, the entire disclosure of which is hereby incorporated by reference for all purposes.

### BACKGROUND

### 1. Field

The present invention relates to a cockpit module for a vehicle.

### 2. Description of the Related Art

In general, with the generation of vehicles, cockpit structures in the vehicles are gradually diversified, and cockpit modules with various shapes are positioned for the respective vehicles depending on the purposes thereof. The cockpit modules, which may meet the needs of vehicle occupants (drivers, fellow passengers, and users), need to be applied depending on traveling environments or purposes for situations. However, because the cockpit module in the related art merely provides a general structure with a limited shape, which leaves inconvenience.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

The present invention is proposed to solve these problems and aims to provide a cockpit module for a vehicle, in which an accommodation space may be provided to additionally accommodate items in addition to a glove box, and a cover, which covers the accommodation space, may be configured to be used as a table, as necessary, which may improve convenience of use.

Technical problems of the present invention are not limited to the aforementioned technical problems, and other technical problems, which are not mentioned above, may be clearly understood by those skilled in the art from the following descriptions.

In a general aspect of the disclosure, a cockpit module for a vehicle, includes: a crash pad including an assembling hole; a tray including an internal space opened upward, the tray being assembled to the assembling hole, the internal space in communication with assembling hole; and a cover rotatably connected to the tray, wherein, in a closed position, the cover covers the internal space as a rotary shaft is rotatably connected to a protruding portion directed toward an inside of an occupant compartment of the tray, wherein, in a deployed position, the cover opens the internal space by being moved upward along the rotary shaft, wherein the cover includes a structure extending toward the inside of the occupant compartment, and wherein the structure is configured to be used as a table at the deployed position.

The cover may include a first body penetrated by extending two opposite ends of the rotary shaft; and a second body horizontally extending from the first body.

An outer surface of the first body may include a semicircular structure, and an outer surface of the second body may include a planar structure continuously connected to the outer surface of the first body.

The cover may further include a third body configured to be withdrawn from the second body, wherein the third body may be provided in a shape that defines a layered structure together with the second body, and wherein the third body may be configured to be deployed in a direction different from an extension direction of the second body or an extension direction of the second body.

The third body may be deployed externally of the second body while sliding or rotating.

The second body may include a seating groove that is configured to accommodate the third body, the seating groove recessed in an inner surface of the second body, wherein guide protrusions may be provided on two opposite surfaces of the third body based on a width direction, and wherein the guide protrusions may be inserted into guide grooves formed in lateral surfaces of the seating groove that are in contact with the guide protrusions.

The cockpit module may further include a cover stopper provided on the rotary shaft and configured to prevent the cover from rotating beyond the deployed position, wherein the cover stopper may be further configured to engage with a catching column disposed inside the crash pad when the cover is positioned at the deployed position while rotating together with the rotary shaft.

The cockpit module may further include a cover spring provided on the rotary shaft, wherein the cover spring may apply a force to return the cover from the deployed position to the closed position.

The cover may include a knob configured to be locked to the tray at the closed position, wherein the knob may be connected to a knob spring and configured to be maintained in a locked state by a force applied by the knob spring.

The tray may include a partition wall configured to divide the internal space into a first region and a second region.

In another general aspect of the disclosure, a cockpit module for a vehicle, includes: a crash pad including an assembling hole; a tray including an internal space, the tray assembled in the assembling hole, the internal space in communication with assembling hole; and a cover rotatably connected to the tray, the cover including an extension structure, wherein, in a closed position, the cover covers an upper portion of the internal space of the tray, and wherein, in a deployed position, the cover rotates to open the internal space of the tray, and the extension structure extends toward the occupant compartment of the vehicle and is configured for use as a table.

The cockpit module may further include a rotary shaft, wherein the cover may include a first body and a second body, wherein the rotary shaft may extend through the first body, and wherein the second body may extend from the first body.

The first body may include a semicircular structure, and the second body may include a planar structure connected to the first body.

The cover may further include a third body configured to extend from the second body, wherein the third body may be stored as a layered structure together with the second body, and wherein the third body may be configured to be deployed in a direction different from an extension direction of the second body.

The third body may be configured to be deployed externally of the second body by at least one of a sliding motion, a rotating motion, or a combination thereof.

The second body may include a seating groove that is configured to accommodate the third body, the seating groove recessed in an inner surface of the second body.

The cockpit module may further include a cover stopper provided on the rotary shaft and configured to prevent the cover from rotating beyond the deployed position, wherein the cover stopper may be further configured to engage a catching column disposed inside the crash pad when the cover is positioned at the deployed position while rotating together with the rotary shaft.

The cockpit module may further include a cover spring provided on the rotary shaft, and the cover spring may apply a force to return the cover from the deployed position to the closed position.

The cover may include a knob configured to be locked to the tray at the closed position, and the knob may be connected to a knob spring and configured to be maintained in a locked state by a force applied by the knob spring.

The cockpit module may further include a cup holder foldably provided on the cover and configured to unfold in the deployed position.

### BRIEF DESCRIPTION OF THE DRAWINGS

FIG. 1 is a view illustrating a cockpit module according to an embodiment of the present invention.

FIG. 2 is a view illustrating a tray and a cover installed on a crash pad of the cockpit module.

FIG. 3 is a view illustrating a state in which the cover is changed between a closed position and a deployed position.

FIG. 4 is a view illustrating a state in which the crash pad, the tray, and the cover are disassembled.

FIG. 5 is a view illustrating the cover.

FIG. 6 is a view illustrating a knob provided on the cover.

FIG. 7 is a view illustrating a cover stopper assembled to a rotary shaft.

FIG. 8 is a view illustrating a state in which the cover stopper is disposed outside a tray.

FIG. 9 is a view illustrating a state in which the cover stopper, together with the cover, is changed between the closed position and the deployed position.

FIGS. 10 to 12 are views illustrating a configuration in which a third body is deployed in a direction different from an extension direction of a second body.

FIG. 13 is a view illustrating a configuration in which the third body is deployed in a direction identical to the extension direction of the second body.

FIG. 14 is a view illustrating an embodiment in which the cover has a cup holder.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, embodiments of the present invention will be described in detail with reference to the accompanying drawings, and components which are the same or correspond to each other will be denoted by the same or corresponding reference numerals in all drawings, and redundant descriptions will be omitted.

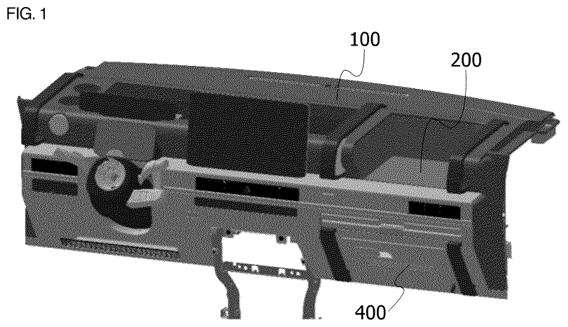

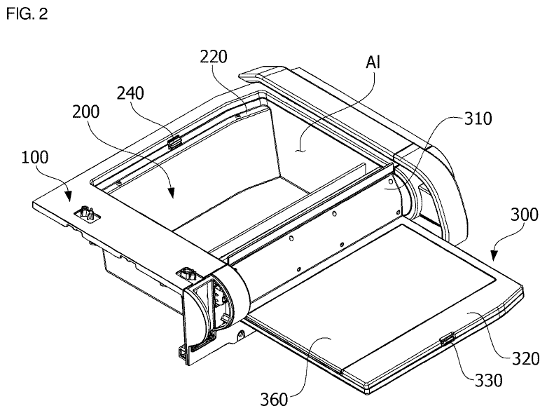

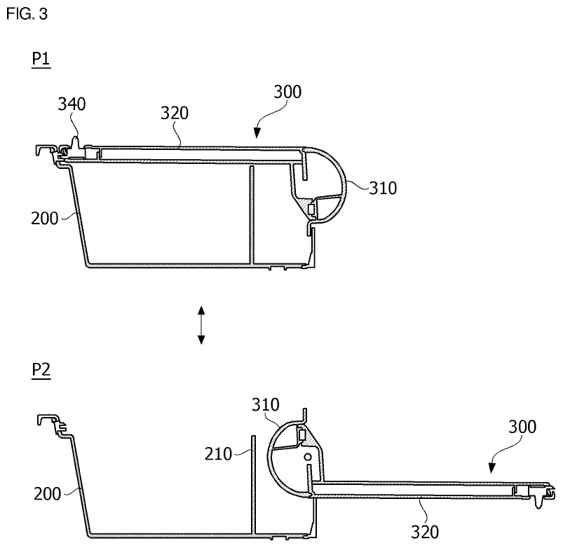

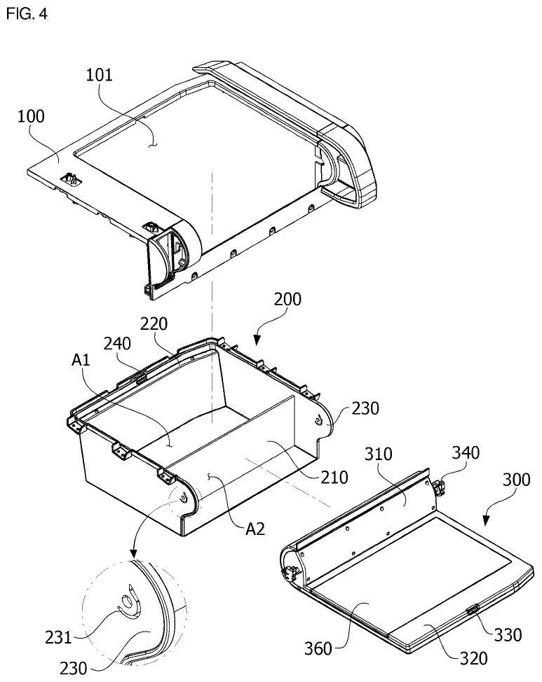

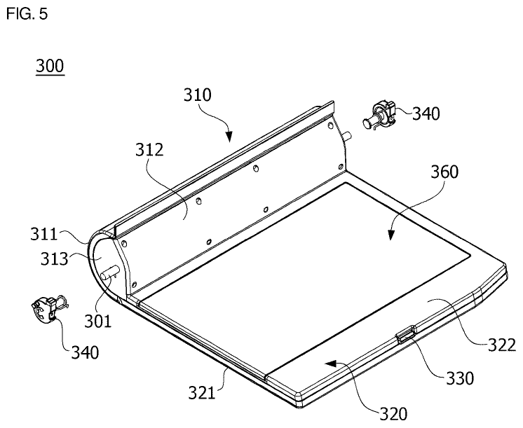

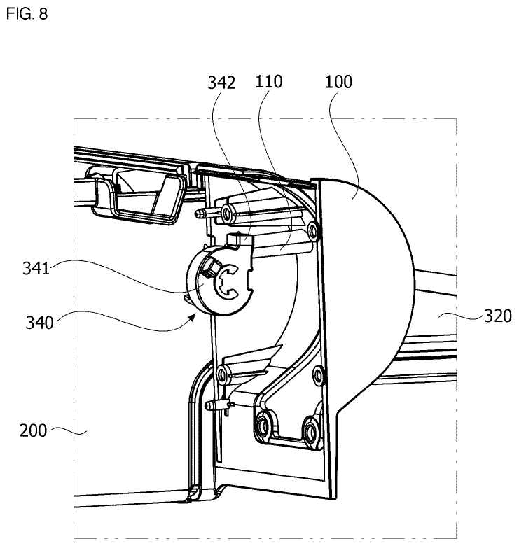

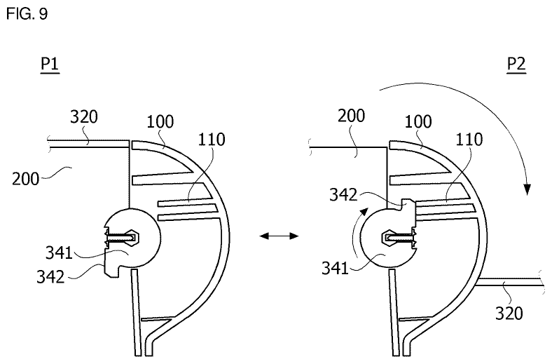

FIGS. 1 to 14 illustrate a cockpit module for a vehicle, a configuration thereof, and an operating state thereof according to the embodiment of the present invention.

With reference to the drawings, the cockpit module for a vehicle according to the embodiment of the present invention may include a crash pad 100, a tray 200, and a cover 300.

The crash pad 100 may be equipped with a glove box 400 provided at a passenger seat position. An assembling hole 101 may be provided in the crash pad 100 and disposed above the glove box 400. The assembling hole 101 may be formed through the crash pad 100 and provided at a position spaced apart from the glove box 400.

The tray 200 may be provided in the form of a box structure with a quadrangular shape as a whole.

The tray 200 may have an internal space opened upward and be assembled and fixed to the assembling hole 101. The internal space may be used as an accommodation space capable of accommodating an item. Therefore, in addition to the glove box 400 disposed at a lower side, the cockpit module is configured to additionally accommodate an item in the tray 200 disposed at an upper side. That is, the tray 200 may provide a separate accommodation space formed in an upper surface of the cockpit module and spaced apart from the glove box 400.

The tray 200 may have a partition wall 210 configured to divide the internal space into a first region A1 and a second region A2. The first region A1 may have a relatively larger size than the second region A2.

The first region A1 may be used as an accommodation space in which an item is accommodated. The second region A2 may be used as an assembling space in which the cover 300 is assembled.

A support part 220, on which an edge of the cover 300 is placed, may be provided in the first region A1. The support part 220 may have a structure that defines a stepped portion together with an upper end of the tray 200. The support part 220 is configured such that the edge of the cover 300 may be placed and supported on the support part 220.

The cover 300 may be configured to close or open the accommodation space.

The cover 300 may be rotatably connected to the tray 200. Specifically, a rotary shaft 301 of the cover 300 may be rotatably connected to protruding portions 230 directed toward an occupant compartment from the second region A2 of the tray 200.

The cover 300 may be configured to be changed between a closed position P1 at which the cover 300 covers the internal space and a deployed position P2 at which the cover 300 opens the internal space by being moved upward while rotating about the rotary shaft 301. At the closed position P1, the cover 300 may be used as a protective cover that covers the internal space and protects the accommodated item. At the deployed position P2, the cover 300 may be disposed to have a structure extending toward the inside of the occupant compartment and used as a table.

The cover 300 may include a first body 310 connected to the tray 200, and a second body 320 horizontally extending from the first body 310.

The first body 310 may have an approximate container structure having an empty space. An outer surface 311 of the first body 310 may have a semicircular structure, and an inner surface 312 of the first body 310 may have a bent structure. The rotary shaft 301 may be connected to the first body 310. Two opposite ends of the rotary shaft 301 may extend while penetrating two opposite surfaces 313 of the first body 310 based on a longitudinal direction.

At the closed position P1, the first body 310 may be disposed such that the inner surface 312 is directed toward the partition wall 210, and the outer surface 311 is exposed toward the inside of the occupant compartment. Further, at the deployed position P2, the first body 310 may be disposed such that the inner surface 312 is exposed toward the inside of the occupant compartment, and the outer surface 311 is directed toward the partition wall 210.

The second body 320 may have an approximately flat plate structure. An outer surface 321 of the second body 320 may have a planar structure continuously connected to the outer surface 311 of the first body 310. An inner surface 322 of the second body 320 may have a planar structure parallel to the outer surface 321.

At the closed position P1, the second body 320 may be disposed such that the inner surface 322 is directed toward the internal space, and the outer surface 321 is exposed to an upper surface of the crash pad 100 toward an upper side of the occupant compartment. Further, at the deployed position P2, the second body 320 may be disposed such that the inner surface 322 is exposed toward the upper side of the occupant compartment, and the outer surface 321 is directed toward a lower side of the occupant compartment.

The cover 300 may have a knob 330 configured to be locked to the tray 200 at the closed position P1.

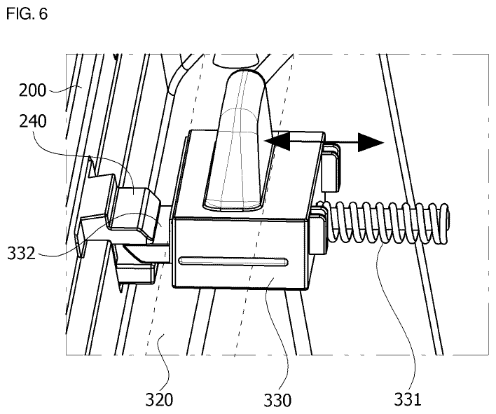

As illustrated in FIG. 6, the knob 330 may be connected to a knob spring 331 and configured to be maintained in a locked state by a force applied by the knob spring 331. The knob 330 and the knob spring 331 may be installed in the second body 320. A protruding end 332 of the knob 330 may protrude to the outside of the second body 320 and be locked by being fitted with a bezel 240 of the tray 200.

It is necessary to restrict a rotation range of the cover 300 when the cover 300 is deployed while rotating from the closed position P1 to the deployed position P2. Specifically, the cover 300 needs to be restrained so that the cover 300 cannot rotate out of a rotation range from the closed position P1 to the deployed position P2, i.e., 180°.

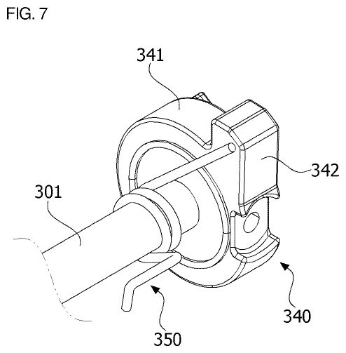

With reference to FIGS. 7 to 9, cover stoppers 340 may be provided on the rotary shaft 301 to prevent the cover 300 for rotating beyond the deployed position P2.

The cover stoppers 340 may be respectively assembled to the two opposite ends of the rotary shaft 301 extending from the first body 310 to the outside. In the state in which the first body 310 is disposed in the second region A2, the cover stoppers 340 may be disposed outside the second region A2 with the protruding portions 230 of the tray 200 interposed therebetween.

The cover stopper 340 may include an approximately circular rotary portion 341 coupled to the rotary shaft 301, and an extension portion 342 protruding and extending from one side of the rotary portion 341 in a tangential direction.

The cover stopper 340 may rotate together with the rotary shaft 301. When the cover 300 is positioned at the deployed position P2, the extension portion 342 may be configured to be caught by a catching column 110 provided inside the crash pad 100. In the state in which the extension portion 342 is blocked by the crash pad 100, the rotations of the cover stoppers 340 and the rotary shaft 301 may be restricted, and the cover 300 may be restrained so as not to be rotated by 180° or more.

As illustrated in FIG. 7, a cover spring 350 may be provided on the rotary shaft 301 and apply a force to return the cover 300 from the deployed position P2 to the closed position P1. In the embodiment, the cover spring 350 may be configured as a torsion spring.

The cover spring 350 may be fitted with the rotary shaft 301 between the protruding portion 230 of the tray 200 and the cover stopper 340, and one end and the other end of the cover spring 350 may be connected to and elastically supported on the first body 310 and the crash pad 100. In this case, a slit hole 231 may be provided in the protruding portion 230, and the cover spring 350 may pass through the slit hole 231. The slit hole 231 may be formed in a shape that surrounds the rotary shaft 301 along a rotation trajectory of the first body 310. Therefore, the cover 300, which is rotated from the closed position P1 to the deployed position P2, may return back to the closed position P1 by an elastic force of the cover spring 350.

In the embodiment, the cover 300 may further include a third body 360 configured to be withdrawn from the second body 320.

The third body 360 may be used as a table in conjunction with the second body 320. That is, the third body 360 may implement a further expanded table in comparison with the table implemented by the second body 320.

Like the second body 320, the third body 360 may be provided in the form of a flat plate structure as a whole and provided in a shape that defines a layered structure together with the second body 320.

In the embodiment, a seating groove 322a may be recessed in the inner surface 322 of the second body 320 and accommodate the third body 360. The seating groove 322a may be formed in a shape corresponding to the third body 360 to fit the third body 360. A depth of the seating groove 322a may correspond to a thickness of the third body 360.

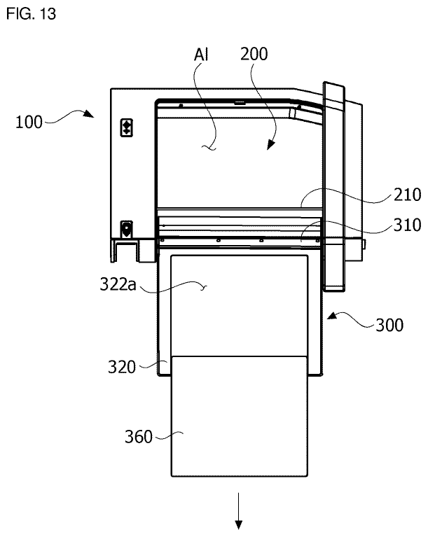

The third body 360 may be configured to be deployed in a direction different from an extension direction of the second body 320. In addition, the third body 360 may be configured to be deployed in a direction identical to the extension direction of the second body 320 (see FIG. 13).

In the embodiment, the third body 360 may be deployed to the outside of the second body 320 while sliding.

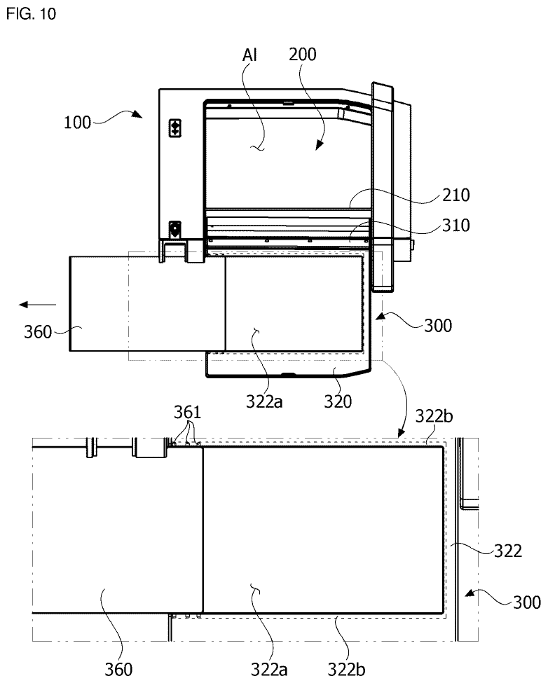

As illustrated in FIG. 10, guide protrusions 361 may be provided on two opposite surfaces of the third body 360 based on a width direction, and guide grooves 322b may be formed in lateral surfaces of the seating groove 322a, which are in contact with the guide protrusions 361, so that the guide protrusions 361 are inserted into the guide grooves 322b. The third body 360 may slide along the guide grooves 322b by means of the guide protrusions 361.

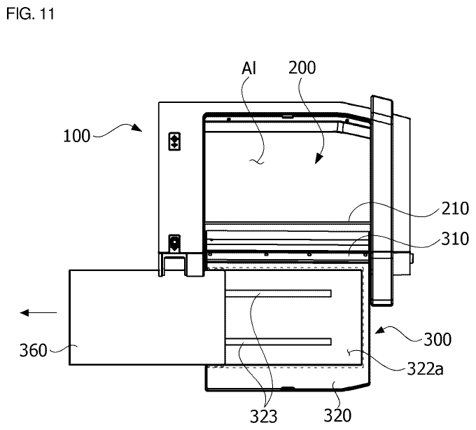

In addition, as illustrated in FIG. 11, sliding rails 323 may be provided between the third body 360 and the second body 320. The sliding rails 323 may be fixed to the seating groove 322a, and the third body 360 may slide along the sliding rails 323.

In the embodiment, the third body 360 may be deployed to the outside of the second body while rotating.

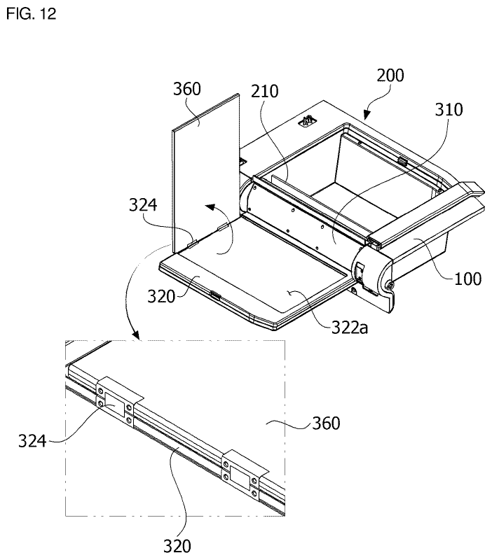

As illustrated in FIG. 12, the third body 360 and the second body 320 may be connected by hinge members 324. The third body may be deployed from the second body 320 or folded while rotating about the hinge member 324.

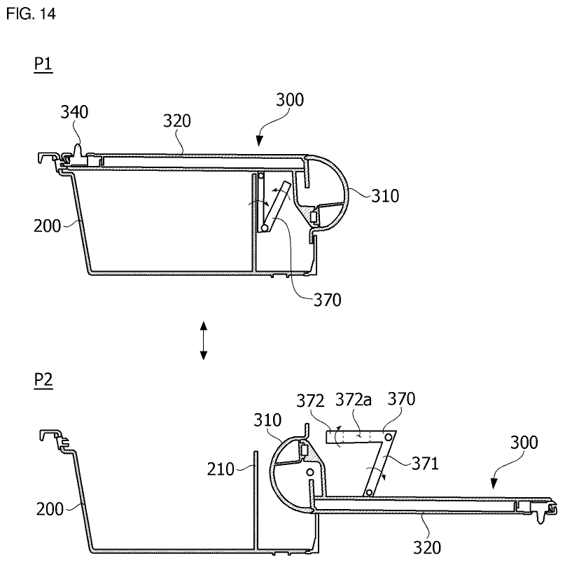

Meanwhile, with reference to FIG. 14, a cup holder 370 may be provided on the cover 300.

The cup holder 370 may be foldably provided on the cover 300. In the embodiment, the cup holder 370 may include a frame part 371 having one end rotatably connected to the first body 310, and a holder part 372 having the other end rotatably connected to the frame part 371. The holder part 372 may have a hole 372a in which a cup or the like may be fixed.

When the cover 300 is positioned at the closed position P1, the frame part 371 and the holder part 372 in the folded state may be disposed in the second region A2. When the cover 300 is deployed to the deployed position P2, the frame part 371 and the holder part 372 may be unfolded to have a preset structure by means of an elastic means (not illustrated) such as a spring.

As described above, according to the embodiment of the present invention, the tray, which has the internal space exposed upward, may be provided on the upper surface of the crash pad, and an item may be separately placed or accommodated in the tray independently of the glove box, which may improve the convenience.

In addition, at ordinary times, the cover, which covers the tray, may be rotated and used as the table when the vehicle is stationary or the user works, which may further improve the convenience of use. The variable table may be applied regardless of a layout of the cockpit module and configured to be expanded to a size that allows the user to work, as necessary.

According to the embodiment of the present invention, it is possible to provide the cockpit module for a vehicle, in which the accommodation space may be provided to additionally accommodate items in addition to the glove box, and the cover, which covers the accommodation space, may be configured to be used as the table, as necessary, which may improve convenience of use.

The effects of the present invention are not limited to the aforementioned effects, and other effects, which are not mentioned above, will be clearly understood by those skilled in the art from the claims.

While the present invention has been described above with reference to the exemplary embodiments, it may be understood by those skilled in the art that the present invention may be variously modified and changed without departing from the spirit and scope of the present invention disclosed in the claims. Further, it should be interpreted that the differences related to the modifications and alterations are included in the scope of the present invention defined by the appended claims.

What is claimed is:

1. A cockpit module for a vehicle, the cockpit module comprising:
a crash pad including an assembling hole;
a tray including an internal space opened upward, the tray being assembled to the assembling hole, the internal space in communication with assembling hole; and
a cover rotatably connected to the tray,
wherein, in a closed position, the cover covers the internal space as a rotary shaft is rotatably connected to a protruding portion directed toward an inside of an occupant compartment of the tray,
wherein, in a deployed position, the cover opens the internal space by being moved upward along the rotary shaft,
wherein the cover includes a structure extending toward the inside of the occupant compartment, and
wherein the structure is configured to be used as a table at the deployed position.

2. The cockpit module of claim 1, wherein the cover comprises:
a first body penetrated by extending two opposite ends of the rotary shaft; and
a second body horizontally extending from the first body.

3. The cockpit module of claim 2,
wherein an outer surface of the first body includes a semicircular structure, and
wherein an outer surface of the second body includes a planar structure continuously connected to the outer surface of the first body.

4. The cockpit module of claim 2,
wherein the cover further comprises a third body configured to be withdrawn from the second body,
wherein the third body is provided in a shape that defines a layered structure together with the second body, and
wherein the third body is configured to be deployed in a direction different from an extension direction of the second body or an extension direction of the second body.

5. The cockpit module of claim 4, wherein the third body is deployed externally of the second body while sliding or rotating.

6. The cockpit module of claim 4,
wherein the second body includes a seating groove that is configured to accommodate the third body, the seating groove recessed in an inner surface of the second body,
wherein guide protrusions are provided on two opposite surfaces of the third body based on a width direction, and
wherein the guide protrusions are inserted into guide grooves formed in lateral surfaces of the seating groove that are in contact with the guide protrusions.

7. The cockpit module of claim 1, further comprising:
a cover stopper provided on the rotary shaft and configured to prevent the cover from rotating beyond the deployed position,
wherein the cover stopper is further configured to engage with a catching column disposed inside the crash pad when the cover is positioned at the deployed position while rotating together with the rotary shaft.

8. The cockpit module of claim 1, further comprising:
a cover spring provided on the rotary shaft,
wherein the cover spring applies a force to return the cover from the deployed position to the closed position.

9. The cockpit module of claim 1,
wherein the cover includes a knob configured to be locked to the tray at the closed position, and
wherein the knob is connected to a knob spring and configured to be maintained in a locked state by a force applied by the knob spring.

10. The cockpit module of claim 1, wherein the tray includes a partition wall configured to divide the internal space into a first region and a second region.

11. A cockpit module for a vehicle, the cockpit module comprising:
a crash pad including an assembling hole;
a tray including an internal space, the tray assembled in the assembling hole, the internal space in communication with assembling hole; and
a cover rotatably connected to the tray, the cover including an extension structure,
wherein, in a closed position, the cover covers an upper portion of the internal space of the tray, and
wherein, in a deployed position, the cover rotates to open the internal space of the tray, and the extension structure extends toward the occupant compartment of the vehicle and is configured for use as a table.

12. The cockpit module of claim 11, further comprising:
a rotary shaft,
wherein the cover includes a first body and a second body,
wherein the rotary shaft extends through the first body, and
wherein the second body extends from the first body.

13. The cockpit module of claim 12,
wherein the first body includes a semicircular structure, and
wherein the second body includes a planar structure connected to the first body.

14. The cockpit module of claim 12,
wherein the cover further comprises a third body configured to extend from the second body,
wherein the third body is stored as a layered structure together with the second body, and
wherein the third body is configured to be deployed in a direction different from an extension direction of the second body.

15. The cockpit module of claim 14, wherein the third body is configured to be deployed externally of the second body by at least one of a sliding motion, a rotating motion, or a combination thereof.

16. The cockpit module of claim 14, wherein the second body includes a seating groove that is configured to accommodate the third body, the seating groove recessed in an inner surface of the second body.

17. The cockpit module of claim 12, further comprising:
a cover stopper provided on the rotary shaft and configured to prevent the cover from rotating beyond the deployed position,
wherein the cover stopper is further configured to engage a catching column disposed inside the crash pad when the cover is positioned at the deployed position while rotating together with the rotary shaft.

18. The cockpit module of claim 11, further comprising:
a cover spring provided on the rotary shaft,
wherein the cover spring applies a force to return the cover from the deployed position to the closed position.

19. The cockpit module of claim 11,
wherein the cover includes a knob configured to be locked to the tray at the closed position, and
wherein the knob is connected to a knob spring and configured to be maintained in a locked state by a force applied by the knob spring.

20. The cockpit module of claim 11, further comprising:
a cup holder foldably provided on the cover and configured to unfold in the deployed position.
